(19) United States
(12) Patent Application Publication
(10) Pub. No.: US 2015/0288517 A1
(43) Pub. Date: Oct. 8, 2015

(54) SYSTEM AND METHOD FOR SECURED COMMUNICATION

(71) Applicant: UT-Battelle, LLC, Oak Ridge, TN (US)

(72) Inventors: Philip G. Evans, Knoxville, TN (US); Nathanael R. Paul, Knoxville, TN (US); Raphael C. Pooser, Knoxville, TN (US)

(21) Appl. No.: 14/245,213

(22) Filed: Apr. 4, 2014

(51) Int. Cl. H04L 9/08; H04L 9/06; H04L 29/06

(52) U.S. Cl. CPC H04L 9/0852; H04L 63/08; H04L 63/04; H04L 9/06; H04L 9/0625; H04L 9/0631

(57) ABSTRACT

Systems and methods for securely communicating with a server device are provided. Both the server device and a client device may be provided pre-shared keys, which may be based on a stream of random digits generated by a quantum random number generator. The client device may promote a new client-side key from among the pre-shared keys for use in secure communication with the server device in response to an event, such as a time-based event (e.g., passage of 30 seconds). The server device may be substantially synchronized with the client device such that a server-side key matches a client-side key being used to communicate securely with the server device.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present invention relates to secure communication, and more specifically to an apparatus and method for securely communicating between at least two devices.

### BACKGROUND OF THE INVENTION

Encrypted communication and authentication between computers occurs on a daily basis. Authentication in many cases helps entities confirm their identity to access information. For example, an entity, such as a user of a computer or software running on the computer, may communicate with another computer to confirm the identity of one or more of the communicating entities, including the user, the software, the computer, or the other computer, or a combination thereof. In this way, entities can operate with a degree of certainty that communications are from whom the communication claims to be.

One type of authentication system prevalent in and outside the Internet utilizes password-only authentication with a username/password combination. Another type of authentication system is a two-factor authentication system often times based on two of the following: (1) something you know, (2) something you have, and (3) something you are (e.g., biometric fingerprint). Authentication transactions using the password-only or two-factor system are nearly ubiquitous in network communications. Password-only authentication systems, or systems solely based on something you know, are deemed to be less secure than two-factor authentication systems because the password-only authentication system is based solely on something you know, which may be subject to exploitation through various techniques, including, for example, brute force and social engineering. Accordingly, there has been increasing interest in the two-factor system in recent times.

Many two-factor authentication systems utilize a password (or personal identification number) and a security token in possession of the entity. The password may be known to the user and a server, and the security token may generate a random number provided to the user and known by the server. In many cases, the server and the token synchronously generate the random number so that the random number given to the user is the same as the random number currently known by the server. The user may authenticate themselves by providing their password and the random number generated by the security token. Put differently, the random number generated from the security token (something you have) may be combined with the password (something you know) to form a conventional two factor authentication system.

Encrypted communication between computers may be achieved in a similar manner by utilizing a random number generated by both the server and a client device. The random number may be utilized as a key in combination with a cryptographic algorithm (e.g., DES and AES) to encrypt information to yield cyphertext for transmission, and to decrypt received cyphertext to obtain the information in plain form.

Due at least in part to access being limited to the server side, the server side is often times considered secure against either the random number or the password becoming known to an adversary or potential attacker. On the user side, the random number is free for anyone in possession of the security token to read, but a degree of security can be provided in that the password may be known only to the user and the server. Additional security may be provided due to the security token being a physical item in possession of the user, and not made easily available to a potential attacker.

This conventional two-factor authentication system, however, is not without drawbacks. Security in the conventional two-factor system is based at least on two assumptions: 1) access to a user's password is strictly limited, and 2) the random numbers on the security token and the server are actually random and cannot be reproduced computationally. If the second premise is subject to compromise, the conventional two-factor systems and conventional encryption systems may be open to compromise.

For instance, a well-known two-factor hardware security token vendor, has been reportedly compromised in recent times. A successful attack on the server-side, which reportedly occurred on the vendor's system, may compromise at least one of the password and the tables of random seeds used as a basis for generating the random numbers. As mentioned above, if only the password is compromised, the second factor, a random number, may still prevent a successful attack. However, if the random number is open to compromise, the underlying assumptions for security in the two-factor authentication system and similar encryption systems may be considered flawed.

More specifically, the inaccurate assumption of security in a conventional two-factor authentication system, similar to the vendor's system, may be characterized as follows. In a conventional two-factor authentication system, a starting seed value S₁ is based on a pseudorandom stream of randomness (or a computationally random seed), and is used for an extended period of time by a hash function. The hash function may be applied recursively such that a hash function chain is developed from the starting seed S₁ to generate a plurality of random numbers. The table below illustrates such a hash function chain based on seed S₁. As can be seen, the output from a previous hash is input to the next hash. In this way, the conventional two-factor authentication system may utilize little storage, and generate random numbers in real time. However, if the hashing algorithm, itself, is reverse engineered, a potential adversary may compute the entire chain of numbers, including the starting seed S₁. Thus, reliance on a pseudorandom stream of randomness based on hash function that is seeded by the pseudorandom stream may be misplaced.

TABLE 1
Conventional hash chain

| | Seed, S₁ |
|---|---|
| T₁ | H(S₁) |
| T₂ | H(H(S₁)) |
| T₃ | H(H(H(S₁))) |
| . . . | . . . |

By using hash computation tables, some which may exploit the fact that neither the pseudorandom seed nor the hash function are truly random, the hashing algorithm or function used to generate the random number may be reverse engineered and reduced to the original seed value. In other words, both the seed and the random numbers based on the seed and the hash function may be reproduced deterministically using identical algorithms on another computer. An attacker may then generate random numbers that mimic those used for encryption or authentication, circumventing security measures put in place by conventional systems.

### SUMMARY OF THE INVENTION

Systems and methods for securely communicating with a server device are provided. Both the server device and a client device may be provided pre-shared keys, which may be based on a stream of random digits generated by a quantum random number generator. The client device may promote a new client-side key from among the pre-shared keys for use in secure communication with the server device in response to an event, such as a time-based event (e.g., passage of 30 seconds). The server device may be substantially synchronized with the client device such that a server-side key matches a client-side key being used to communicate securely with the server device.

In one embodiment, a method of promoting a key for secure communication between a client device and a server device includes the step of storing, in the client device, a random stream of digits generated from a quantum random number generator, where a plurality of pre-shared keys are defined by the random stream, and where the server device includes a copy of the pre-shared keys. In response to an event, the client device may promote a key from among the plurality of pre-shared keys, and securely communicate to the server using the promoted key. Secure communication may include transmitting at least one of a multiple factor authentication request and encrypted information. In an example authentication request, the request may be a multiple factor authentication request with the promoted key and a user password.

A variety of events may trigger promotion of a new key. As an example, the event may be a time-based event, such as every 30 seconds. Other examples of events include a number of uses associated with the promoted key exceeding a threshold, and reception of a remote command.

In one aspect, a client device configured to securely communicate with a server device may include a processor operable to execute preprogrammed instructions, and a memory operable to store a plurality of pre-shared keys generated from a quantum random number generator and computer programmed instructions executable by the processor. The computer programmed instructions may include directives to promote an initial key from a plurality of pre-shared keys, where a copy of the pre-shared keys is stored on the server device, and to securely communicate with the server device using the initial key. The computer programmed instructions may also include directives to promote a second key from the plurality of pre-shared keys in response to an event, and to securely communicate with the server device using the second key.

Secure communication from the client device to the server device using the initial key may include transmitting at least one of a multiple factor authentication request and encrypted information. Encrypted information may be generated by supplying the information in plain form to a cryptographic algorithm and the initial key.

In another aspect, a system for securely communicating between a client device and a server device may include providing from a quantum random number generator a plurality of pre-shared keys for storage in both the client device and the server device. The client device and the server device may synchronously use keys from the pre-shared keys such that at any given time, a client-side key being used by the client device may correspond to the server-side key being used by the server device.

The systems and methods described herein attempt to break away from or avoid dependence solely on computational security for communication. In other words, the reliance on a pseudorandom stream of randomness based on a function that is seeded by an unknown value may be less secure than systems and methods described herein. And, by using the systems and methods described herein, entities may avoid part of the security threats believed to be in conventional secure communication systems.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a system according to an embodiment of the present invention.

FIG. 2 is a system according to an embodiment of the present invention.

FIG. 3 is a method according to an embodiment of the present invention.

FIG. 4 is a method according to an embodiment of the present invention.

FIG. 5 is a quantum random number generator according to an embodiment of the present invention.

FIG. 6 is a quantum random number generator according to an embodiment of the present invention.

### DETAILED DESCRIPTION

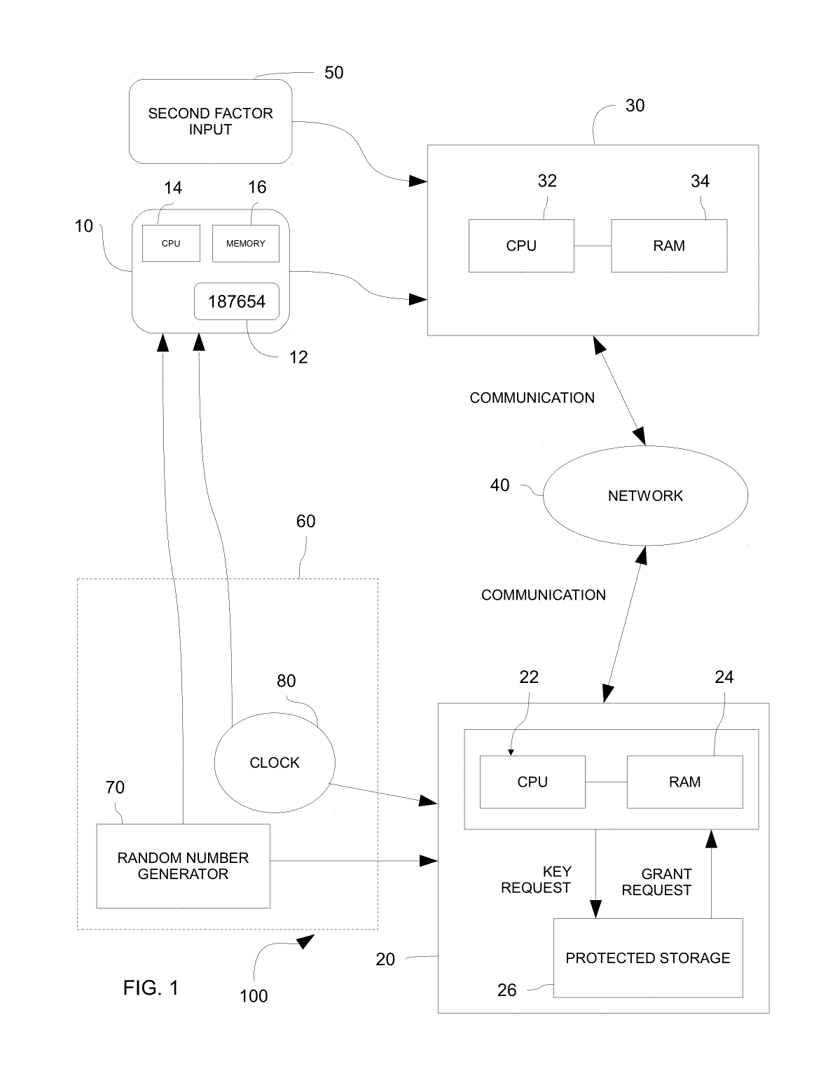

A system and method for authentication in accordance with one or more embodiments of the present invention is shown in FIGS. 1-3. As set forth below, the system and method may utilize pre-shared keys, provided to both a client device and a server device, to enable secured communication between the client device and the server device. The pre-shared keys, or private keys, may be generated and provided at manufacture to each of the client device and the server device. In one embodiment, the pre-shared keys may be truly random and not generated deterministically. By synchronizing the clocks of the client device and the server device in this embodiment, both the client device and the server device may index through the pre-shared keys in a synchronous manner so that both devices utilize the same pre-shared key for any given period. Because the pre-shared keys are truly random and not generated deterministically, attempts to compromise communication or fake authentication by guessing the pre-shared keys may be impossible. Each key from the pre-shared keys may not be functionally related to the other keys, unlike a hashing function based-system depending on one or more seeds, so that even if an adversary were to guess one key, the remaining keys may remain secure. In this way, reverse engineering or computing the pre-shared keys may be impossible, short of physically breaking into the server device or the client device and absconding with the list of pre-shared keys. Security measures may be put in place to try to prevent such unauthorized physical access.

In one embodiment, the secured communication may include two-factor authentication for authenticating an entity as being whom they claim to be. However, it should be understood that the features described herein are not limited to two-factor authentication systems, and may be utilized in other authentication methodologies, such as single or multiple factor authentication systems between two or more entities, or a combination thereof.

In addition to or alternatively, the secured communication, based on the pre-shared keys, may include encrypted communication between the client and server devices. Using a pre-shared key in conjunction with a cryptographic algorithm (e.g., DES or AES) may enable the client and server devices to communicate securely. For example, a client device may communicate encrypted information or cyphertext to the server device by providing the information in plain form along with the pre-shared key to the cryptographic algorithm, the output of which yields cyphertext for transmission to the server device.

Referring now to the illustrated embodiment of FIG. 1, a system according to one embodiment of the present invention is generally designated 100, and includes a client device 10 and a server device 20. The server device 20 may include an internal processor/CPU 22, internal memory/RAM 24, and protected storage 26. The client device 10 in the illustrated embodiment is a security token having an internal processor 14, internal memory, and protected storage 16, which may be similar to internal processor 22 and protected storage 26 of the server device 20. It should be understood that the client device 10 is not limited to a security token, and that any type of device capable of storing and utilizing a pre-shared key may be used to enable secured communication with the server device 20.

The client device 10 may facilitate authentication with the server device 20, and may be portable such that it can be carried by a person, or may be integrated into another device, such as a smart meter, appliance or other device, for authentication. The pre-shared keys used in secured communication may be stored in the protected storage 26 of the server device 20. Likewise, the pre-shared keys used in secured communication may be stored in the protected storage 16 of the client device 10. The protected storage 16 may be potted such that attempts to open the client device 10 to access the pre-shared keys destroys the contents of the protected storage 16 before it can be compromised.

As will be described herein, the pre-shared keys may be based on a truly random stream generated from a quantum random number generator, such as random generator 70. Generation and distribution of the pre-shared keys may occur in a pre-shared key generation stage 60. The pre-shared key generation stage 60 may occur during manufacture of the client device 10 or the server device 20, or both, or during a setup phase in which the client device 10 and the server device 20 are associated with each other for secure communication. In one embodiment, pre-shared key generation stage 60 may include providing both the client device 10 and the server device 20 along with a synchronization signal based on a clock 80.

As an example, the client device 10 and the server device 20 may be provided the pre-shared keys and a clock synchronization signal at manufacture. The client device 10 may also be synchronized, loosely or precisely, with the server device 20 such that selection of a key from among the pre-shared keys may be synchronized. In this way, a key from among the pre-shared keys used by the client device 10 at any given time may correspond to a key requested or obtained from the protected memory 26 of the server device 20.

In the illustrated embodiment, the client device 10 includes a display 12 capable of presenting the key for use in authentication. It should be understood that the client device 10 may communicate the key through channels other than the display 12, such as a network 40, and that the client device 10, in some embodiments, may not include the display 12. The server device 20, similar to the client device 10, may be a standalone server or device or may be integrated into other components or devices.

As shown in the illustrated embodiment of FIG. 1, the system 100 includes an authentication client device 30 through which an entity, such as a user, may authenticate with the server device 20. The authentication client device 30 may include an internal processor 32 and internal memory 34, and the ability to communicate with the server device 20 through a network 40. The authentication client device 30 may be configured to authenticate a user with the server device 20 at least in part based on a key, from among the pre-shared keys, provided by the client device 10, enabling the user or entity to obtain access to privileged information. In one embodiment, the authentication client device 30 may be configured to authenticate a user according to a two-factor method, described in further detail below, that also includes obtaining a second input 50, such as a password or personal identification number (PIN), from the entity in addition to the key provided by the client device 10. Both the second input 50 and the key may be processed by the internal processor 32 and communicated to the server device 20 in an authentication request.

Each of the client device 10, the server device 20, and the authentication client device 30 may be a standalone device or an embedded device that is incorporated into a machine or system. For example, each of the client device 10, the server device 20, and the authentication client device 30 may be a mainframe, a super computer, a PC or Apple Mac personal computer, a hand-held device, a smart phone, or a central processing unit. These devices may be programmed with a series of instructions that, when executed, cause the device to perform authentication according to one or more embodiments described herein. These instructions may be stored on a machine-readable data storage device, which, in one embodiment, may be the internal memory of the client device 10, the server device 20, or the authentication client device 30, or a combination thereof.

The machine-readable data storage device may store machine language and may be a portable memory device that is readable by at least one of the client device 10, the server device 20, and the authentication client device 30. Such a portable memory device can be a compact disk (CD), digital video disk (DVD), a Flash Drive, any other disk readable by a disk drive embedded or externally connected to a computer, a memory stick, or any other portable storage medium. Alternatively, the machine-readable data storage device can be an embedded component of a computer such as a hard disk or a flash drive of a computer. The machine-readable data storage device can be a standalone device or a device that is embedded into a machine or system that uses the instructions for a useful result, such as one or more of the client device 10, the server device 20, and the authentication client device 30.

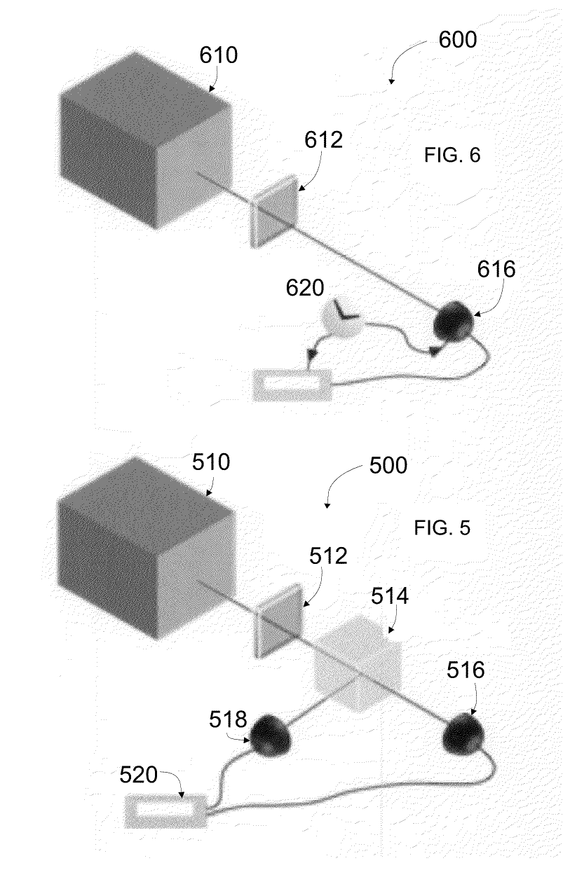

The random number generator 70 may generate a truly random stream of randomness to be used in defining the pre-shared keys. The random number generator 70 may be a quantum random number generator (QRNG), such as the QRNG 500 and QRNG 600 depicted in FIGS. 5 and 6. Quantum mechanics provides an inherent randomness from nature that is considered computationally non-deterministic; the randomness afforded by nature is considered truly random or unbreakable with computational power. QRNGs may attempt to benefit from nature's randomness to generate a random number. In the QRNGs depicted in FIGS. 5 and 6, probabilistic, natural processes may be partially controlled by an observer, and monitored to record random events. These recorded random events may be incorporated into random numbers.

In the illustrated embodiment of FIG. 5, the QRNG 500 may utilize photon emissions from a laser 510 as a quantum mechanical process for generating random numbers. Photons from the laser may be directed toward a neutral density filter 512 and a 50/50 beam splitter 514, 50% reflecting and 50% transmitting. Two detectors 516, 518 may be positioned to detect which path a photon takes, which may be truly random according to quantum mechanics. In this way, a transmitted photon may be detected as a binary 1 and a reflected photon may be detected as a binary 0, thereby being used to generate a random number. Logic circuitry 520 may count the binary 0s and 1s to produce the random number. The 50/50 beam splitter 514 may be misaligned to some degree in the QRNG 500, potentially introducing bias toward 0s or 1s. Bias may also be introduced in operation of the laser 510 itself, and through the use of two separate detectors 516, 518. This bias may be accounted for or substantially reduced by adjustments to one or more operating parameters of the QRNG 500 or by computational methods to cancel the bias from the random stream. The one or more operating parameters may be adjusted in real-time or manually.

In the illustrated embodiment of FIG. 6, the QRNG 600 may be similar to the QRNG 500, with a few exceptions. The QRNG 600 may include a laser 610, a neutral density filter 612, and a detector 616 similar to the laser 510, the neutral density filter 512, and the detector 516. The QRNG 600 may implement a time-resolved measurement of photons from the laser 610 as a basis for using quantum mechanics to generate a random number. In the QRNG 600, the arrival time of photons may be detected relative to one another, and after a sufficient number of data points are detected, the distribution may provide enough entropy for a random number. Timing and logic circuitry 620, such as time-to-digital conversion circuitry, may correlate the arrival time of photons to a random number. Although the QRNG 600 may not be as susceptible to bias introduced through a beam splitter or use of two detectors, the arrival distribution of photons emitted from the laser operated may have some shape (such as a sharp peak at a particular arrival time) that results in bias. Similar to the QRNG 500, this bias may be accounted for or substantially reduced by adjustments to one or more operating parameters of the QRNG 600 or by computational methods to substantially cancel the bias from the random stream. The one or more operating parameters may be adjusted in real-time or manually.

It should be understood that the random number generator 70 is not limited to the QRNGs shown and described with respect to the illustrated embodiments of FIGS. 5 and 6, and that any type of true random number generator may be used to generate a truly random stream, including, for example, one or more of the embodiments described in U.S. patent application Ser. No. 14/147,131, entitled QUANTUM RANDOM NUMBER GENERATOR, filed on Jan. 3, 2014, to Pooser et al., and U.S. patent application Ser. No. 14/178,863, entitled SELF-CORRECTING RANDOM NUMBER GENERATOR, filed on Feb. 12, 2014, to Humble et al.—the disclosures of which are incorporated by reference herein in their entirety. For example, the random number generator 70 may be a QRNG having a laser operated in a spontaneous mode below a lasing threshold to emit photons. Photons emitted from the laser may have at least one random characteristic, which may be monitored by the QRNG to generate a random number. The laser may include a photon emitter and an amplifier coupled to the photon emitter, which may enable the photon generator to be used in the QRNG without introducing significant bias in the random number. The amplifier may also desensitize the photon generator to fluctuations in power supplied thereto while operating in the spontaneous mode. The amplifier may also be a tapered amplifier having an optical cavity, between a photon input and a photon output, that tapers. For example, the optical cavity may be dimensionally larger near the photon output than near the photon input. In one embodiment, the photon emitter and the tapered amplifier may be an integrated component including a semiconductor. The integrated component may be a tapered amplifier diode laser.

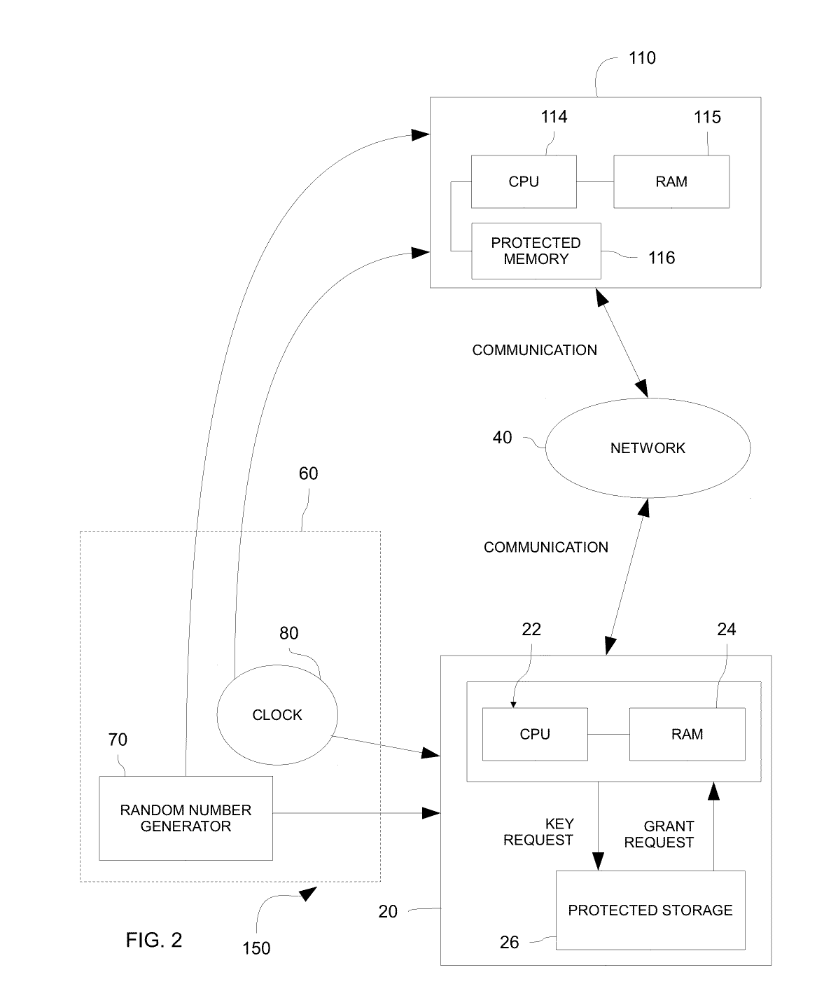

Turning to FIG. 2, a system according to one embodiment of the present invention is generally designated 150, and is similar to the illustrated embodiment of FIG. 1, including a server device 20, but with several exceptions. In the illustrated embodiment of FIG. 2, the client device 110 may include a processor 114, memory 115, and protected memory 116, similar to the client device 10. Instead of using a display or other interface to provide a key as depicted in FIG. 1, the client device 110 may securely communicate via the network 40 using the currently promoted key. Secure communication in the illustrated embodiment of FIG. 2 may include encrypting and decrypting information using the key and a cryptographic algorithm. In this way, information in plain form may be translated to cyphertext for communication over the network to the server device 20, which may decrypt the cyphertext using a server-side key, matching the key used by the client device 110, and the cryptographic algorithm.

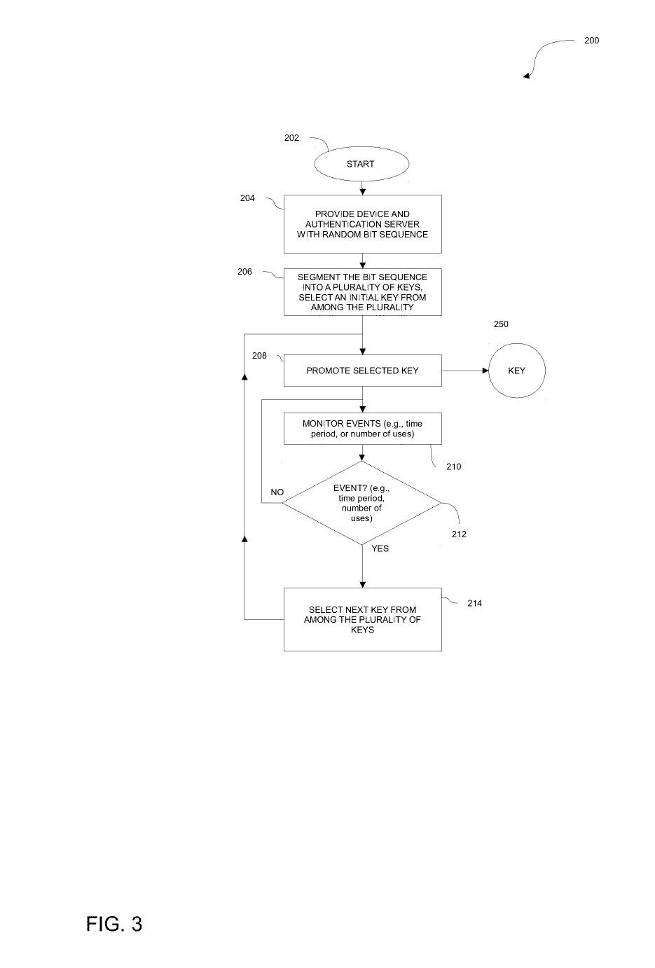

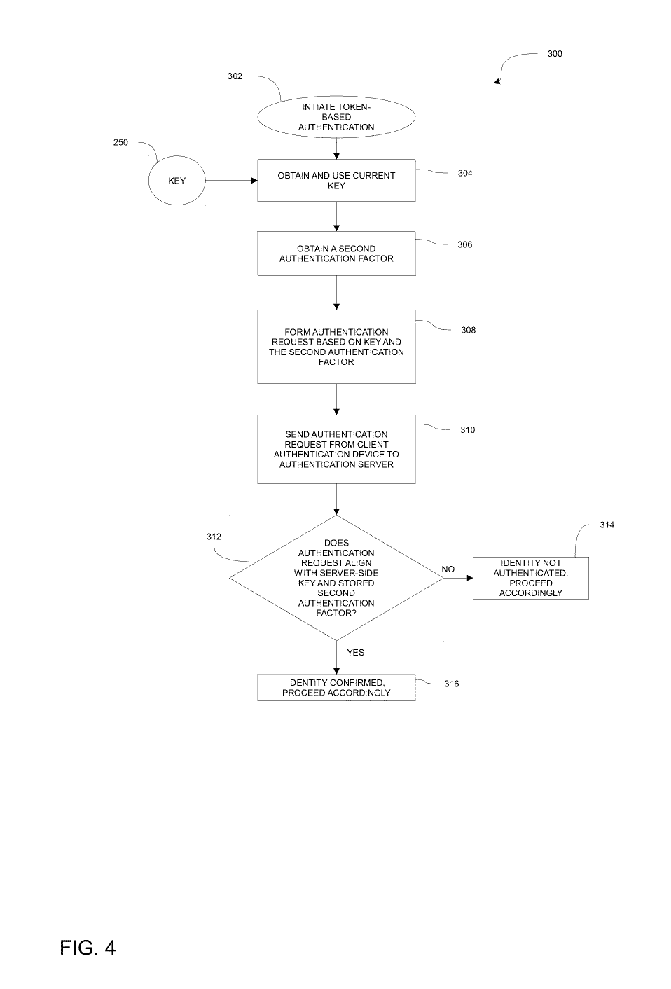

Operation of the systems depicted in FIGS. 1 and 2 according to one or more embodiments will now be described with reference to the method and steps depicted in FIGS. 3-4. As will become apparent below, a method according to one or more embodiments may provide or promote a key by indexing through a truly random stream of randomness, which defines a set of pre-shared keys provided to both a client device 10 and a server device 20. For example, a method according to one embodiment of the present invention may implement one or more features and steps described in U.S. patent application Ser. No. 14/052,065, entitled SYSTEM AND METHOD FOR KEY GENERATION IN SECURITY TOKENS, filed on Oct. 11, 2013, to Evans et al., U.S. patent application Ser. No. 13/435,481, entitled SLOW AND PERSISTENT PHASED KEY GENERATION, filed on Mar. 30, 2012, to Paul et al., and its provisional application, U.S. Provisional Patent Application No. 61/496,199, entitled SLOW AND PERSISTENT PHASED KEY GENERATOR, filed on Mar. 30, 2011, to Paul et al.—the disclosures of which are incorporated by reference herein in their entirety. In addition to or alternatively, the method according to the illustrated embodiment may utilize protected storage in one or more of the client device 10, the server device 20, and the authentication client device 30 to aid in secure authentication.

As depicted in the illustrated embodiment of FIG. 3, a method designated 200 for promoting a key for use in secured communication includes using a stream of random bits as a source of randomness. Step 204. A set of pre-shared keys may be defined by the source of randomness, which may be distributed to both the client device 10 and the server device 20, and stored in protected memory therein.

The method 200 may be implemented in both the client device 10 and the server device 20 such that the key used by the client device 10 for authentication or encryption, or both, generally corresponds to the key used by the server device 20. In one embodiment, the client device 10 and the server device 20 may synchronize, loosely or precisely, with a clock such that at any given time, the promoted keys in the client device 10 and server device 20 are the same. For example, the client device 10 and the server device 20 may each promote a new key from among a plurality of pre-shared keys after a predetermined time period (e.g., once per minute), where the clocks or timers in the client device 10 and the server device 20 are synchronized such that promotion of new keys occurs at substantially the same time, as depicted in the table below.

TABLE 2

| Time | Client | Server |
|---|---|---|
| T₁ | K₁ | K₁ |
| T₂ | K₂ | K₂ |
| T₃ | K₃ | K₃ |
| . . . | . . . | |

In addition to or alternatively, the client device 10 and the server device 20 may synchronize promotion of new keys based on events, such as after a predetermined number of messages or authentication requests, or based on a remote command, or a combination thereof. Although operation according to the method 200 is described in connection with the client device 10 and the server device 20, it should be understood that all or some steps may be shared or performed, or both, in other devices, such as the authentication client device 30. As an example, the client device 10 and the authentication client device 30 may be integrated such that all steps performed by the client device 10 according to the method 200 may be performed by the authentication client device 30.

The method 200 includes segmenting that stream of random bits stream into a plurality of segments. Steps 204 and 206. Rather than using the plurality of segments as a seed for one or more hash chains based on iterative application of a hash function, each of the plurality of segments may be used as a key. Segments of N random bits provided at step 204 may be promoted or made available as the current key for authentication or encryption. Steps 208, 250.

The currently promoted key may remain current until an event occurs, triggering promotion of a new key. Steps 210, 212, 214. In one embodiment, the event may be time based, such as after an amount of time has passed (e.g., 30 seconds) such that the client device 10 and the server device 20 may each promote a new key in a generally synchronized manner. In addition to or alternatively, the event may be based on factors other than time, such as the occurrence of a predetermined number of authentication requests or messages, or in response to a remote message, which may be sent from at least one of the client device 10, the server device 20, the authentication client device 30, or another device. Put differently, in response to the occurrence of an event that triggers promotion of a new key, the client device 10 or server device 20, or both, may index to the next key or segment of the stream. Steps 208, 210, 212 and 214. By indexing through the pre-shared keys, defined by a truly random stream of bits, a potential adversary may not be able to compromise communication, even if the adversary were to guess one key from among the plurality of pre-shared keys.

The security of such a system may be further enhanced by decreasing the time interval between promotion of new keys. Indeed, as the time interval approaches zero, the security of this private pre-shared key method may approach that of the one-time pad, which is considered by many to be impossible to compromise if used correctly.

In promoting each new key, one or more of the pre-shared keys may be made available to the respective processors 14, 22 of the client device 10 and the server device 20. The pre-shared keys, themselves, may be encrypted and stored in protected memory in the client device 10, or the server device 20, or both. Because time between use of the pre-shared keys may be relatively long (e.g., 30 seconds), the pre-shared keys may be encrypted and stored in protected memory without significant time penalty associated with decryption for promotion of a new key. Decrypting the pre-shared keys may be computationally intensive, but because the pre-shared keys may not be used with significant frequency, the time penalty associated with decryption may not significantly affect performance. In one embodiment, the time penalty may be acceptable such that a high bit encryption may be used to encrypt and store the pre-shared keys in protected memory.

As an example, by encrypting the pre-shared keys in protected memory, if an adversary attacks the server device 20 and attempts to access the stored pre-shared keys, access to all of the pre-shared keys may be prevented or deterred. If a new key is promoted every 30 seconds, then the pre-shared keys may be available at a rate of one every 30 seconds, while the full list of pre-shared keys remains encrypted. If access to the protected memory is attempted, the protected memory may self-destruct.

As depicted in the illustrated embodiment of FIG. 4, a method designated 300 for authenticating client device 10 using a key is described. Once a user or entity initiates authentication, the client device 10 may obtain the current key, such as the key provided according to the method 200 described in connection with the illustrated embodiment of FIG. 3. Step 302, 304. As mentioned above in connection with the illustrated embodiment of FIG. 1, the authentication client device 30 may be configured to obtain a second authentication factor, such as a password, personal identification number (PIN) or biometric identifier. Step 306. In one embodiment, a user may provide both the key displayed by the client device 10 and the second authentication factor to the authentication client device 30 through a user interface. For example, in one embodiment in which the client device 10 is a security token, the user may read the key currently displayed by the security token, and enter the key into the authentication client device 30 along with the user's password.

In the illustrated embodiment of FIG. 4, the key and the second authentication factor may be processed by the authentication client device 30 to form an authentication request, which may be communicated to the server device 20. Step 310. One or more of processing, formation, and communication of the authentication request may be conducted on a device other than the authentication client device 30. The server device 20 may compare the authentication request to a server-side key generated and obtained according to a method described in connection with the illustrated embodiment of FIG. 3. It should be understood that both the client device 10 and the server device 20 may be running separate but similar processes to arrive at the same key for authentication purposes. The server device 20 may also compare the authentication request to a version of the second authentication factor, which may be stored in protected storage 26 of the server device 20, or may be obtained from an external source, such as another authentication server. Step 312. Based on the comparison between (1) the authentication request and (2) the server-side key and stored second authentication factor, the server device 20 may confirm the identity of the entity from which the authentication request came. Steps 312 and 316. If the comparison indicates inconsistencies between the authentication request and the server-side key and the stored second authentication factor, the server device 20 may not authenticate the entity from which the authentication request came. Steps 312 and 314. If the entity is not authenticated, the server device 20 in one embodiment may deny access to privileged information that would otherwise be available to an authenticated entity.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method of promoting a key for secure communication between a client device and a server device, said method comprising the steps of:
storing, in the client device, a random stream of digits generated from a quantum random number generator, wherein a plurality of pre-shared keys are defined by the random stream, wherein the server device includes a copy of the pre-shared keys;
in response to an event, promoting a key from among the plurality of pre-shared keys; and
securely communicating from the client device to the server using the promoted key.

2. The method of claim 1 wherein securely communicating from the client device to the server device using the promoted key includes transmitting at least one of a multiple factor authentication request and encrypted information.

3. The method of claim 2 further comprising generating the encrypted information based on a cryptographic algorithm and the promoted key.

4. The method of claim 3 wherein the encryption algorithm is at least one of AES and DES.

5. The method of claim 2 wherein the client device is a security authentication token for authentication of an entity, the security token being physically associated with the entity, wherein the promoted key is used in the multiple factor authentication request to authenticate the entity to the server device.

6. The method of claim 1 wherein the event includes at least one of a time-based event, a number of uses associated with the promoted key exceeding a threshold, and reception of a remote command.

7. The method of claim 1 further comprising segmenting the random stream into the plurality of pre-shared keys.

8. The method of claim 1 wherein said storing the random stream includes encrypting the random stream and storing the encrypted random stream in protected memory.

9. The method of claim 8 further comprising in response to physical tampering of the protected memory, destroying the contents of the protected memory.

10. The method of claim 8 wherein said promoting a key includes decrypting the random stream from protected memory.

11. A client device configured to secure communication with a server device, said client device comprising:
a processor operable to execute preprogrammed instructions;
a memory operable to store a plurality of pre-shared keys generated from a quantum random number generator and computer programmed instructions executable by said processor for performing the steps of:
promoting an initial key from said plurality of pre-shared keys, wherein a copy of said pre-shared keys is stored on the server device;
securely communicating with the server device using said initial key;
in response to an event, promoting a second key from said plurality of pre-shared keys; and
securely communicating with the server device using said second key.

12. The client device of claim 11 wherein securely communicating from said client device to the server device using said initial key includes transmitting at least one of a multiple factor authentication request and encrypted information.

13. The client device of claim 12 wherein said memory stores computer programmed instructions executable by said processor to generate said encrypted information based on a cryptographic algorithm and said initial key.

14. The client device of claim 13 wherein said cryptographic algorithm is at least one of AES and DES.

15. The client device of claim 12 wherein said client device is a security authentication token for authentication of an entity, said security token being physically associated with the entity, wherein said initial key is used in said multiple factor authentication request to authenticate the entity to the server device.

16. The client device of claim 15 wherein said security token includes a display, wherein said memory includes computer programmed instructions to display a currently promoted key from among said plurality of pre-shared keys.

17. The client device of claim 11 wherein said event includes at least one of a time-based event, a number of uses associated with said initial key exceeding a threshold, and reception of a remote command.

18. A system for securely communicating between a client device and a server device, said system comprising:
said client device and said server device including protected memory, said client device and said server device configured to store in respective protected memory a plurality of pre-shared keys, wherein said pre-shared keys are based on a random number generated from a quantum random number generator;
wherein said client device is configured to promote a client-side key from said plurality of pre-shared keys in response to an event;
wherein said server device is substantially synchronized with said client device such that promotion of said client-side key in said client device coincides with promotion of a server-side key in said server device that matches said client-side key; and
wherein said client device and said server device are configured to use said client-side key and said server side-key to securely communicate with each other.

19. The system of claim 18 wherein said event includes at least one of a time-based event and a number of uses of a prior key exceeding a threshold.

20. The system of claim 18 wherein said client device and said server device are configured to utilize said client-side key and said server-side key to encrypt and decrypt information.
